(19) United States
(12) Patent Application Publication
(10) Pub. No.: US 2010/0116147 A1
(43) Pub. Date: May 13, 2010

(54) BIFURCATED HEATED TOASTER PLATEN

(75) Inventors: Terry Tae-Il Chung, Bartlett, IL (US); Brian Hee-Eun Lee, West Chicago, IL (US); Loren Veltrop, Chicago, IL (US); Donald Van Erden, Wildwood, IL (US)

Correspondence Address: Docket Clerk, 1000 JORIE BOULEVARD SUITE 144, OAK BROOK, IL, 60523, US

(73) Assignee: PRINCE CASTLE INC., Carol Stream, IL (US)

(21) Appl. No.: 12/267,449

(22) Filed: Nov. 7, 2008

(51) Int. Cl. A47J 37/08

(52) U.S. Cl. 99/386

(57) ABSTRACT

A food heating device usable as a toaster, fryer or warmer uses a metal plate having separately heated regions separated by a thermal break. The separately heated regions use separately energized and controlled heating elements embedded to the material from which the metal plate is made. One region can be kept hot while the other region is shut off or kept at a lower temperature until demand requires both sides to be heated. Separating the regions by a thermal break reduces heat transfer from the hot side to the cool side.

### FIELD OF THE INVENTION

This invention relates to an energy-efficient platen for warming and toasting food products that include bread slices, sandwich buns, rolls, croissants, bagels, muffins and flat bread. It is particularly useful in continuous-feed toasters used in fast food restaurants. It can also be used to fry foods.

### BACKGROUND OF THE INVENTION

Platen toasters, i.e., toasters that toast or brown foods using a hot, flat plate, are preferred by many food services and fast food restaurants because they are fast, provide an almost completely-uniform color change (Maillard reaction) across the surface of a food item and they tend to dry a food item less than radiant energy toasters. Platen toasters are fast because they supply the Maillard reaction-generating heat energy through a direct, physical contact, instead of infrared transmitted from a hot wire. They produce a uniform color change across the surface of a food item because the platen surface is smooth and the platen's temperature is uniform or nearly uniform. They tend to retain moisture in foods because the surface of the food product being browned or toasted is carmellized before significant water loss can occur, sealing water into the food product.

A problem with platen-equipped toasters is their energy inefficiency. A platen won't effectuate a Maillard reaction, i.e., it won't toast or brown food, unless its temperature is between about 250 degrees and 600 degrees ° F. A cold platen, i.e., a platen at room temperature, will require a significant amount of time for it to pre-heat before it can be used. When a platen toaster used in a fast food restaurant, the platen must be kept at or near operating temperature all the time, which requires energy to be continuously supplied to the platen in order for it to be able to toast and brown foods relatively quickly or on demand. Reducing the energy consumed by a platen toaster, such as those used in high-volume food services and fast food restaurants would be an improvement over the prior art.

### BRIEF DESCRIPTION OF THE DRAWINGS

FIG. 1 is a side view of a metal plate or platen having two, separately heated sections that are separated from each other by an air-filled opening defined by thin, narrow connecting blocks;

FIG. 2 is a cross section of the metal plate shown in FIG. 1 taken along section lines 2-2;

FIG. 3 is a top view of the metal plate shown in FIG. 1;

FIG. 4 is a side view of a metal plate used as a platen, a separately heated region of which how two sections with different thicknesses;

FIG. 5 is a top view of the metal plate shown in FIG. 4;

FIG. 6 is a side view of a metal plate having two, separately heated sections that are separated from each other by a block of thermally-insulating material;

FIG. 7 is a top view of the metal plate shown in FIG. 6 and showing that the two separately heated sections have different thicknesses;

FIG. 8 is a perspective view of a frusto-pyramidal metal “plate” divided into two, separately heated sections separated from each other by a thermally-insulative layer;

FIG. 9 is a side or end view of the metal plate depicted in FIG. 8;

FIG. 10 is a perspective view of a metal plate having a first section in the shape of a frusto-pyramid and a second section in the shape of a rectangular parallel piped;

FIG. 11 is an end view of the metal plate depicted in FIG. 10;

FIG. 12 is a perspective view of a metal plate having two, separately heated regions defined by a thermal break embodied as a void embedded within the plate; and

FIG. 13 is a perspective view of a metal plate having a thermal break embodied as a slot or channel formed into the plate between two, separately heated regions;

FIG. 14 is a side view of a metal plate having two, separate sections heated by embedded, electrically resistive heating elements that are crenellated;

FIG. 15 is a top view of the metal plate shown in FIG. 14;

FIG. 16 is a metal plate having two separate sections that are separately heated but which are separated by a non-linear thermal break, which resembles an inverted truncated pyramid-shaped region filled with thermally insulating material;

FIG. 17 is a cross sectional view of a continuous feed toaster equipped with a conveyor and a platen having separately heated sections, such as the platens depicted in FIGS. 1-16.

FIG. 18 is a side view of an alternate embodiment of a platen, having an opening in one section to allow a food product to pass through the platen;

FIG. 19 is a side view of two separately heated platens;

FIG. 20 is a side view of a toaster using the two platens depicted in FIG. 19; and

FIG. 21 is a top view of a toaster using the platens depicted in FIG. 19.

### DETAILED DESCRIPTION

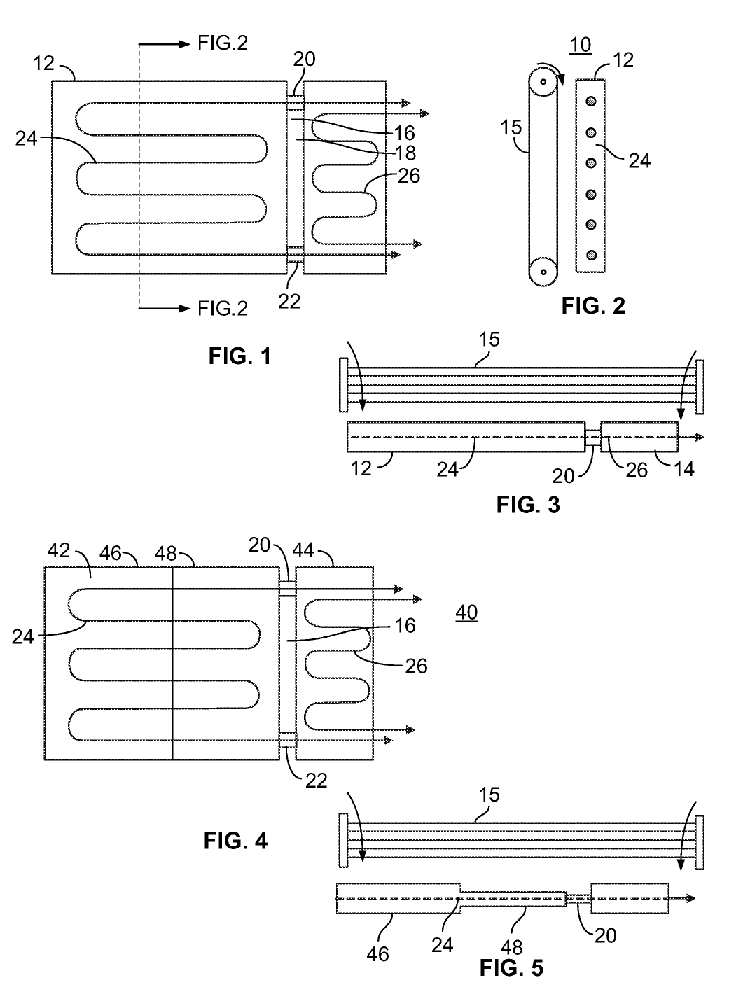

FIG. 1 is a side view of a metal plate, which is also referred to herein as platen 10, having bifurcated heating surfaces. Stated another way, FIG. 1 is a side view of a metal plate having two, separately heated sections 12, 14, which are also referred to herein as regions, separated from each other by thermal break, 16. The thermal break 16 in the platen of FIG. 1 is embodied as an elongated, rectangular air-filled gap or channel 18. The long sides of air-filled gap 18 are defined by the side edges of the two separately heated sections 12, 14 that face each other. The short sides of the air-filled gap are defined by two thin, narrow connecting blocks 20 and 22 that hold the two sections 12 and 14 fixedly attached to each other and which can provide an electrical conduit as set forth below. The connecting blocks 20 and 22 are spaced apart from each other as shown, to enhance the flow of cooling air between the two heated sections 12 and 14.

The two separately-heated sections 12, 14 can be made from separate platens connected to each using screws, bolts or other fasteners that extend through the connecting blocks and at least part way through the sections 12 and 14. For purposes of clarity, however, the fasteners holding the sections 12 and 14 together are not shown in the figures. The two separately-heated sections can also be molded using a single casting with resistive conductors embedded within them.

The electrically-resistive heater conductor wires 24 and 26 embedded within the material forming the platen can follow virtually any path. In order to evenly heat the platen, however, the conductors preferably follow a uniform pattern, such as a boustrophedonic path as shown or a crenellate path not shown. The number of loops and their spacing from adjacent loops in each region 12 and 14 is a design choice but increasing the number of boustrophedonic or crenellate loops tends to reduce temperature variations across the surface of the respective regions 12 and 14, i.e., more loops provide a more even temperature throughout the heated regions' surface area.

FIG. 2 is a cut-away view of the platen 10 taken along section lines 2-2. FIG. 3 is a top view of the platen 10 shown in FIG. 1 and depicting the top view of a conveyor 15 used in a continuous toaster and which drags a food product along the platen. It can be seen in FIGS. 2 and 3 that the platen 10 is relatively thin and flat. The opposing sides of the platen 10 are planar or substantially planar and parallel to each other.

Since the regions 12 are 14 are provided with separate conductors, the operating temperatures of the regions 12 and 14 are therefore individually and separately controllable if the heater conductors 24 and 26 are connected to separate and individually-controllable electrical power sources. Such power sources are not shown in the figures, but well known to those of ordinary skill in the art. The thermal break 16 between the regions 12 and 14 keeps one region from sinking heat energy from the other region. The ability to control the temperature of the regions separately and independently in combination with the thermal break between them enables a restaurant or food service operator to keep at least part of a platen at or near operating temperature at all times with the added ability to have a larger hot area brought on line when demand increases. Keeping a relatively small-area platen hot with the ability to provide a much larger hot surface area can provide an energy savings as compared to what would be required to keep hot all the time, a platen that is large enough to handle peak demand requirements.

It can be seen in the figures that the first conductor 24 extends through the second region 14 of the platen 10 before it reaches the first region 12. In such an embodiment, the connector blocks 20 and 22 provide a conduit for the embedded conductor 24 and mechanically hold the two sections 12 and 14 together. In an alternate embodiment, however, the electrical connections to the two heater conductors do not need to pass through the connector blocks 20 and 22 but can instead extend from one or two different edges of the two different regions 12 and 14.

FIGS. 4 and 5 depict an alternate embodiment of the platen 10 depicted in FIGS. 1-3. In FIG. 4 the platen 40 has two separately heated sections 42 and 44 that are separated from each other by the thermal break 16. As can be seen in FIG. 5 however, which is a top view of the platen 40, the platen 40 has two, separately heated sections 42 and 44, one of which has two different portions or sub-sections 46 and 48, which are of different thicknesses. More particularly, the left-side or first section 42 of the platen 40 has two sub-sections 46 and 48, which are of different thicknesses. The different thickness sub-sections 46 and 48 of the platen 40 can accommodate cooking, frying or toasting different thickness foods evenly, using a single conveyor.

When the platen 40 of FIGS. 4 and 5 is used in a continuous feed toaster with a conveyor 15 that extends across the entire platen 40 as shown, the conveyor 15 will exert a substantially equal compressive forces on food products having different thickness that correspond to the different separation spacings between the conveyor 15 and the different thickness sub-sections 46 and 48. Changing the thickness of sections of the platen can therefore accommodate the ability to cook, e,g., toast, fry or brown different thickness food or bread products at the same time.

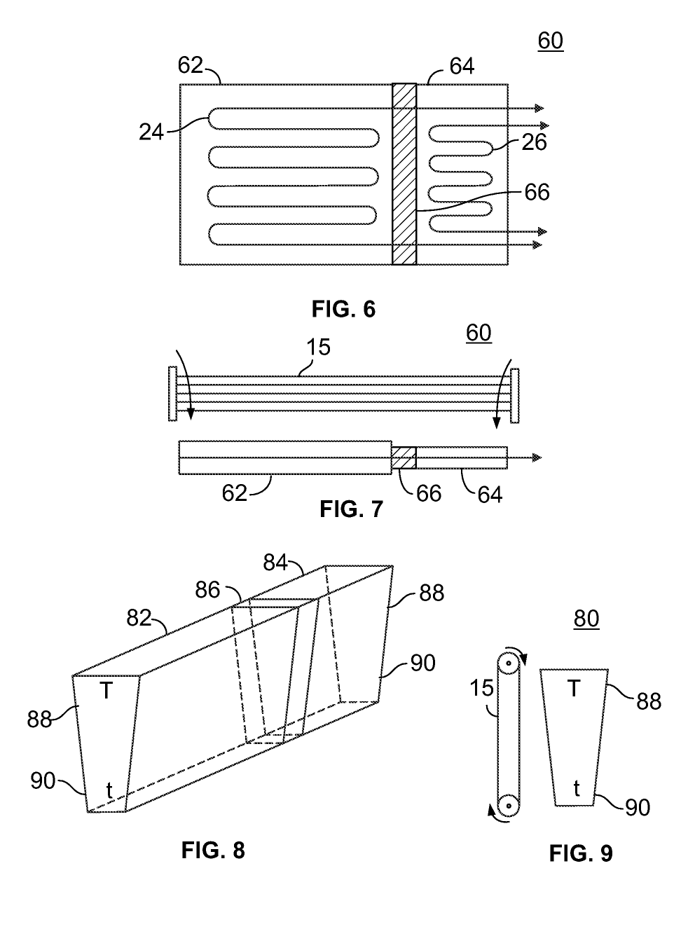

FIGS. 6 and 7 are side and top views respectively of yet another embodiment of a platen 60 having separately heated regions 62 and 64 separated by a thermal break 66. As can be seen in FIG. 7, the left-side or first regions 62 has a thickness greater than that of the right-side or second region 64. As with the embodiment depicted in FIGS. 4 and 5, the different thickness regions can accommodate food products of different thicknesses. When the platen 60 is used with a conveyor 15 parallel to the platen 60, the left-side 62 will thus accommodate a thicker bun or other food product than will the right side 64. The platen depicted in FIGS. 6 and 7 can accommodate the heating (toasting, frying) of different food products, including different food products of different thicknesses by adjusting the left side 62 and right side 64 temperatures, the different thicknesses and the spacing of the conveyor 15 away from the platen 40.

FIG. 8 is a perspective view of yet another embodiment of a platen 80 having two, separately heated sections 82 and 84 separated from each other by a thermal break 86, which is embodied as a slab of thermally insulative material. FIG. 9 is an end or side view. Electrically separate and separately controlled heating elements are embedded in the two sections 82 and 84, just as they are shown in FIGS. 1 and 4 but in FIGS. 8 and 9, the heating elements embedded in the two sections 82 and 84 are omitted from the figures for clarity and simplicity.

In FIG. 8, the shape of the “platen” is reminiscent of an inverted truncated pyramid, which is also referred to herein as a frustrum of a rectangular pyramid. A top portion 88 of both sections 82 and 84 has a thickness “T” greater than the thickness “t” near the bottom portion 90. The differing thickness between the top portion and bottom portion, which is exaggerated in the figures, imbues the “platen” with a taper. When used with a planar and level conveyor 15, the conveyor will urge a food product against the top portion 88 with a greater force than it will urge a food product against the lower or bottom portion 90 due to the fact that a planar conveyor and the thicker top portion 88 will tend to squeeze or urge a food product against the “platen” 80 with more force than at the thinner bottom portion 90. The platen depicted in FIGS. 8 and 9 can thus be used to effectuate the initiation of the Maillard process faster at the thicker top portion 88 than at the bottom portion 90.

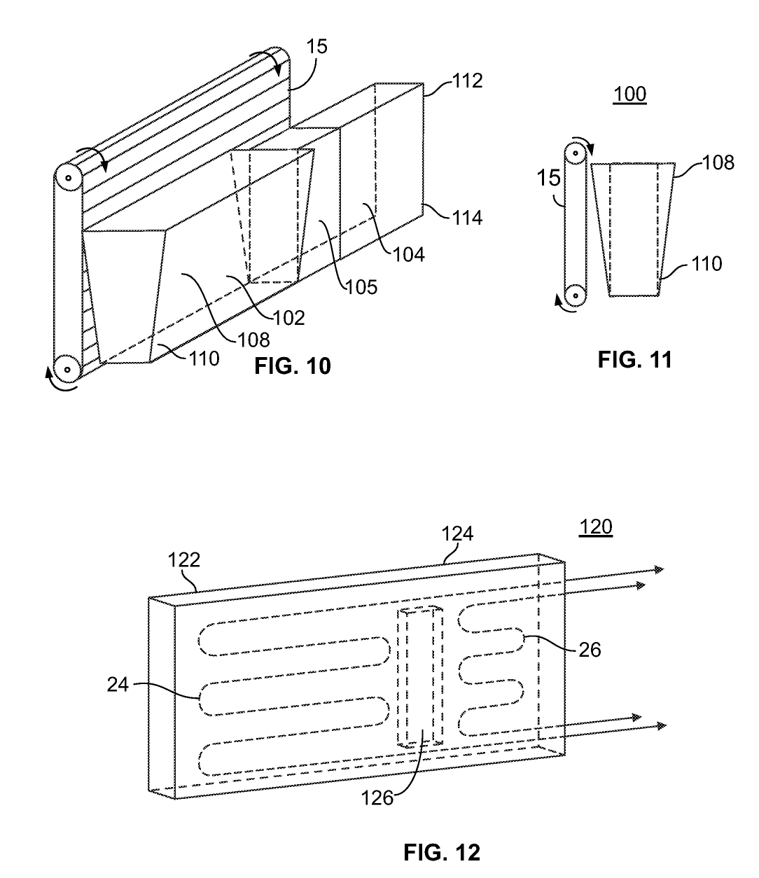

The platen embodiment depicted in FIGS. 10 and 11 is similar to the embodiment depicted in FIGS. 8 and 9. In FIGS. 10 and 11, the two separately heated sections 102 and 104 are separated by a thermal break 105, preferably embodied as a solid block of thermally insulative material. Unlike the embodiment depicted in FIGS. 8 and 9, in FIGS. 10 and 11, only one of the two separately heated sections 102 and 104 is tapered. Stated another way, the top portion 108 of the first heated section 102 is wider than the bottom portion 110 of the first section whereas the second heated section 104 is a regular rectangular prism having a substantially uniform thickness from its top 112 to its bottom 114. Such an embodiment enables a rapid initial toasting on the first side 102 with a conventional toasting on the second side 104.

FIG. 12 depicts yet another embodiment of a platen 120 having first and second separately heated sections or regions 122 and 124 separated by a thermal break 126. FIG. 12 differs from the other embodiments depicted in FIGS. 1-11 in that the thermal break 126 is embodied as a void region formed into the material from which the platen 120 is cast. The void region 126 thus inhibits heat transfer between the two sides 122 and 126 to that which can be conducted through the material surrounding the void 126 while enabling the platen 120 surface to be seamless, owing to the fact that no other material is sandwiched between the two separately heated regions 122 and 124.

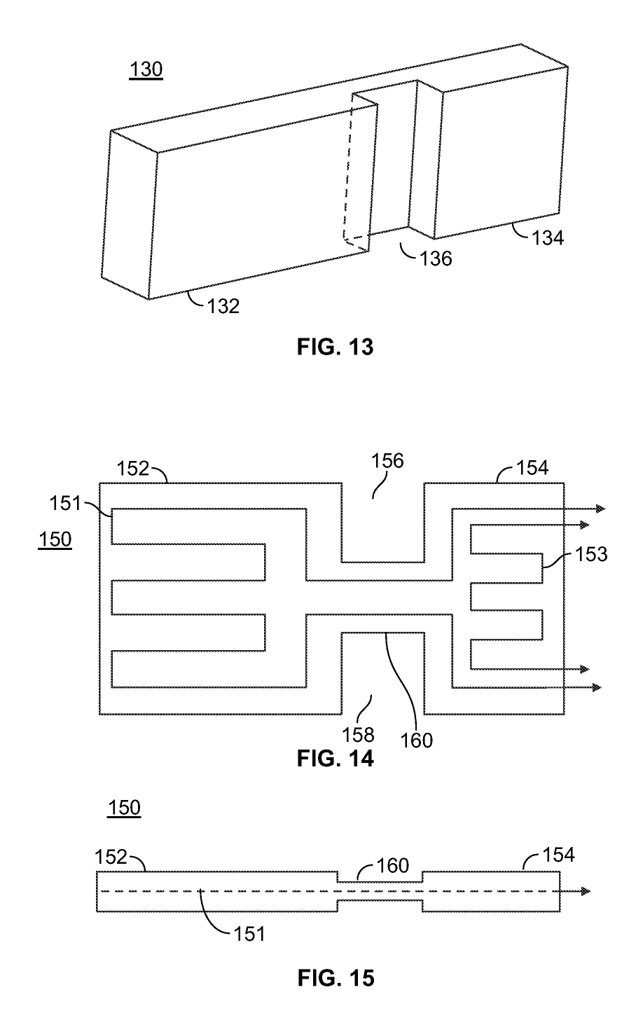

FIG. 13 depicts a platen 130 wherein the separately heated sections 132 and 134 are separated by a thermal break embodied as an air filled channel 136 that extends only part way through the thickness of the platen 130. As with the other embodiments depicted in FIGS. 1-12, separately controlled heating elements are embedded in each section 132 and 134 but they are not shown in the figure for clarity and simplicity.

Those of ordinary skill in the art will recognize that heat will conduct from one section 132 or 134 to the other 134 or 132 through the material that remains at the bottom of the channel 136. For that reason, in order to minimize heat transfer between the two sections 132 and 134, the channel 136 is preferably made to be as deep and as wide as possible.

FIGS. 14 and 15 depict respectively a side view and a top view of yet another embodiment of a platen 150 having separately heated sections separated by a thermal break. In FIG. 15, the separately heated sections 152 and 154 are separated from each other by thermal break embodied as the air gaps 156 and 158 defined by a single connection block 160. As can be seen in FIG. 15, the single connection block 160 is thinner than either of the two heated sections 152 and 154 in order to reduce the cross sectional area of platen material that can conduct heat energy between the two sections 152 and 154.

In addition to having a single connection block 160, the platen 150 employs electrically resistive heater wires 151 and 153, the end sections of which form crenellations. The crenellate-shaped wire heaters 151 and 153 can provide more uniform heating of the platen 10 near the edges.

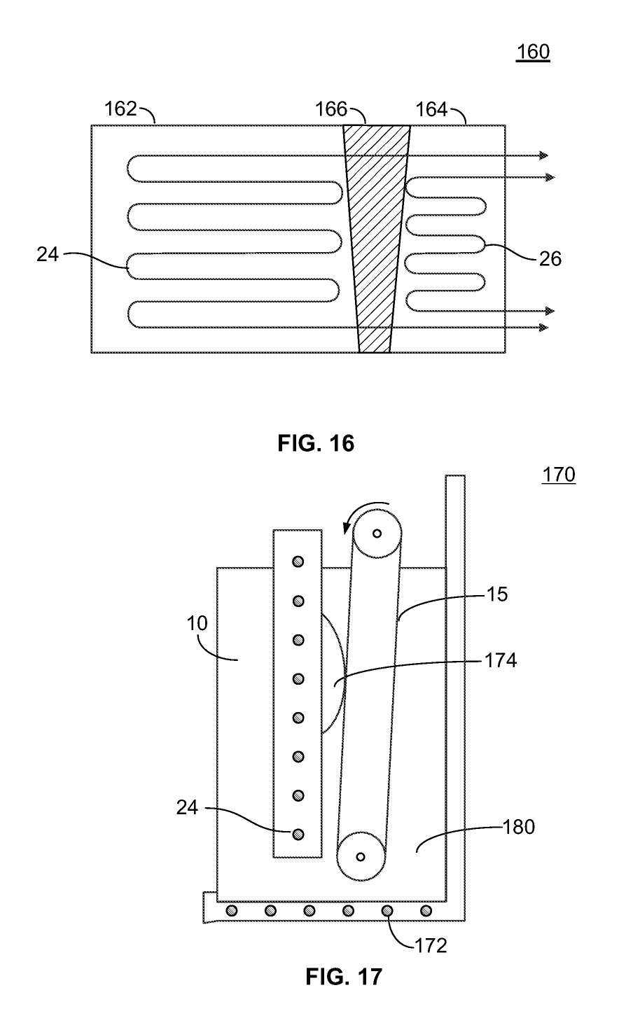

FIG. 16 shows a side view of yet another embodiment of a platen 160 having first and second separately heated regions 162 and 164 separated by a non-linear thermal break 166, which is embodied in FIG. 16 as a trapezoidal-shaped block of thermally insulating material.

Finally, FIG. 17 shows a side view of a continuous feed toaster 170 implemented with a platen having two, separately heated regions separated by a thermal break, such as the platen 10 depicted in FIGS. 1-3. A top portion 174 of a bun is driven downward in the toaster 170 by the conveyor 15. As the bun moves along the platen, it is toasted by the platen and drops into a heated storage compartment 180, the temperature of which is kept above ambient by a heater element 172 at the bottom of the compartment 180. The inclination angle of the platen relative to the conveyor is such that the conveyor and platen tend to squeeze or compress the food product as it moves along the cooking path, having been at least partially cooked in the process. Squeezing the food product can effectuate the release of grease and other liquids from meat products.

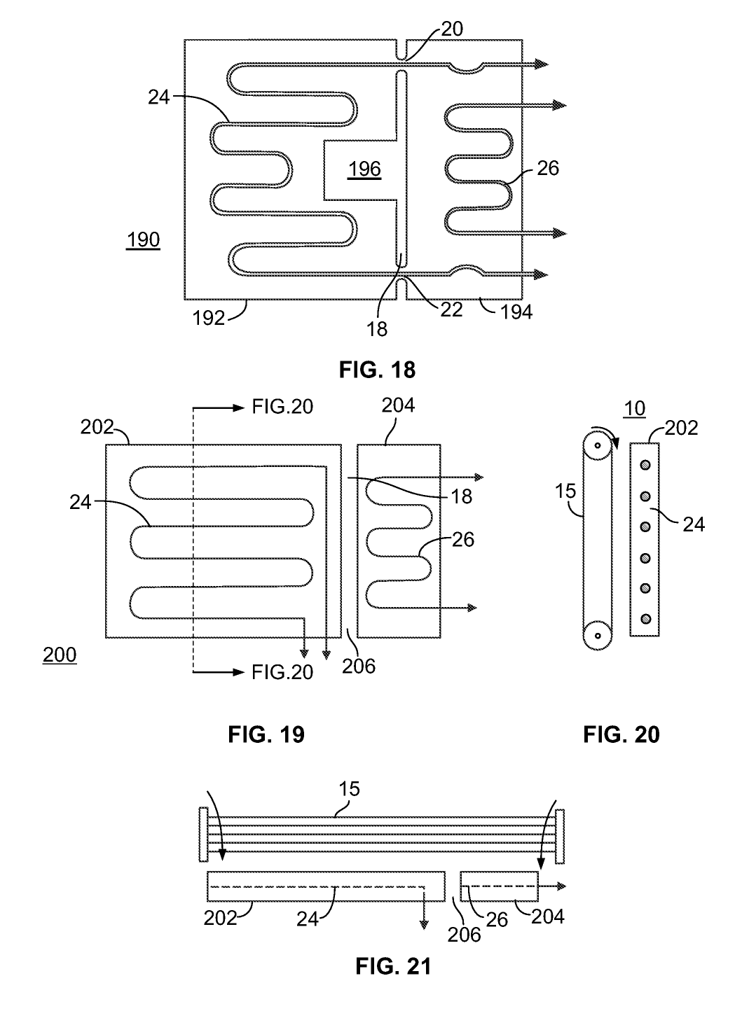

FIG. 18 depicts an alternate embodiment of a platen 190 having separately heated sections 192 and 194 separated from each other by a thermal break 18. The separately heated sections are coupled together by the aforementioned connecting blocks 20 and 22. The thermal break is comprised of an air-filled gap. Each section 192 and 194 includes an electrically resistive heating element embedded in the sections as described above. The heating sections can be of virtually any geometry, preferred ones being either boustrophedonic (shown) or crenellated (not shown in FIG. 18).

In FIG. 18, one of the separately heated sections 192 includes a window or opening 196 through which a food product can pass from one side of a heated platen 190 to the other side (not shown). In such an embodiment, a food product is conveyed part way down the one side 192 of the platen 190 being heated on one side. When the food product meets the window 196, it is translated through the window 196, by a lip on the window's lower edge or a ramp, not shown, to the opposite side of the platen 190. A conveyor on the opposite of the platen (not shown), continues to move the food product along the platen 190 such that the food product is heated on its other side.

FIG. 19 shows a side view of another alternate embodiment of a platen 200, which is comprised of two, separate and individually heated platens 202 and 204, which are completely separated from each other by a thermal break 206 embodied as an air-filled gap between the platens 202 and 204. FIG. 20 shows a side or end view of the platens shown in FIG. 19, which also shows the conveyor 15 used to move food products along the platens 202 and 204. FIG. 21 shows a top view of the toaster.

It is important to note that the platens 202 and 204 in FIG. 19 are not coupled to each other but are instead fixed in place relative to each other by brackets (not shown). As with the platens described above and depicted in the other figures, the each section 202 and 204 includes heating sections embedded in the sections, which can be of virtually any geometry, the preferred ones being either boustrophedonic (shown) or crenellated (not shown in FIG. 19).

It is also important to note that the platen depicted in FIGS. 19-21 is an example of how each of the platens depicted in FIGS. 1-18 can be modified such that the separately-heated sections are completely separated from each other as shown in FIGS. 19-21. Stated another way, each of the platens depicted in FIGS. 1-17 can be alternately embodied by keeping the separately heated sections, separated from each other by an air gap. Such alternate embodiments of the platens should also be considered to be within the scope of the appurtenant claims.

The platens described above and shown in the figures are preferably formed using a thermally conductive material, such as cast aluminum, which has a relatively high heat transfer coefficient k. Thermal insulation between the separately heated sections can be provided by any appropriate material having a thermal transfer coefficient less than the material from which the heated sections are formed such as glass, ceramics and high-temperature plastics. Air can also be used as a thermal break.

In each of the embodiments described herein, the surfaces of the platens are optionally provided with one or more layers of non-stick or friction-reducing material applied to the surfaces or, one or more sheets of non-stick or friction-reducing material. One such material is polytetrafluoroethylene (PTFE), which is also known as TEFLON™. The application of PTFE to a metal surface is well known in the art. Other embodiments use one or more discrete, replaceable sheets of PTFE draped over and held adjacent to surfaces of the platens used to cook (toast or brown, heat or fry) foods. PTFE sheets are known in the art but often use fiberglass fibers to strengthen them such that they resist tearing. Since the platens described herein are used to prepare foods, it is preferable that PTFE sheets used with the platens herein be either completely free fiberglass or essentially free of fiberglass to reduce the likelihood of fiberglass fibers being transferred into a food product. The PTFE sheets used with the platens described herein preferably employ PTFE filaments that interlock each other at angles between 15 and 175 degrees, to improve their tensile strength, necessitated by the fact that they are free of fiberglass or essentially free.

In the embodiments shown in the figures and described above, the separately heated sections are depicted as rectangular. Each section therefore has a corresponding height and a width and a corresponding surface area. While the descriptions of each embodiment refer to sections or regions, which are shown in the figures as being rectangular and which are shown in the figures as being of unequal areas, it should be understood that separately heated regions do not need to be rectangular or of any other particular geometric shape. Other equivalent alternate embodiments include separately heated sections that are trapezoidal, triangular or semi-circular. Moreover, areas of the separately heated regions are not necessarily equal or unequal. Equivalent alternate embodiments include platens having separately heated regions or sections, the areas of which are both equal and unequal, all of which are considered to be within the scope of the appurtenant claims.

The platens described above and depicted in the figures provide bifurcated heating sections, by which is meant, two or more separately heated regions thermally separated from each other by a thermal break. Such a platen enables a food service or restaurant that serves food products like toasted bread slices, sandwich buns, rolls, croissants, bagels, muffins and flat bread to be able to cook them on demand. It also enables food services and restaurants to be able to fry foods on a hot, flat surface, keeping at least one region at or near the relatively high operating temperature, at all times, or nearly all times. When demand increases over the course of a day, as usually happens in most restaurants, the second region of the platen can be brought on line, i.e., heated to an appropriate operating temperature range, typically between 250 and 600 F°, simply by turning on the power, thereby significantly increase food processing capacity. As demand wanes, the second region can be shut off or its input power reduced in order to reduce energy consumption.

While each embodiment described above is considered to be within the scope of the appurtenant claims, the scope of invention is not defined by embodiments described above but is instead defined by the appurtenant claims.

1. A food heating device comprised of:
a metal plate having a plurality of separately heated regions separated by a thermal break.

2. The food heating device of claim 1, wherein a first separately heated region includes a first embedded heating element and wherein a second separately heated region includes a second embedded heating element.

3. The food heating device of claim 2, wherein the plate is configured such that the first heated region can be selectively heated to at least a first temperature within a first temperature range and the second heated region can be selectively heated to at least a second temperature within a second temperature range.

4. The food heating device of claim 1, wherein first and second separately heated regions have first and second thicknesses respectively.

5. The food heating device of claim 1, wherein at least one of the separately heated regions has a first section and a second section and wherein one of the first and second sections have first and second different thickness.

6. The food heating device of claim 1, wherein the metal plate has a first top portion and a first bottom and wherein the metal plate has a thickness, which varies between said first top portion and the first bottom portion.

7. The food heating device of claim 6, wherein the first top portion and the first bottom portion are located in one of the plurality of separately heated regions.

8. The food heating device of claim 2, wherein the food heating device is a toaster and wherein the metal plate and embedded heating elements are configured to toast a bread product.

9. The food heating device of claim 8, wherein the food heating device includes a heated, food storage compartment.

10. The food heating device of claim 1, wherein the thermal break is non-linear.

11. The food heating device of claim 1, wherein the thermal break is comprised of at least one, air-filled channel that extends at least part way across the metal plate and wherein the metal plate has a thickness such that the at least one air-filled channel extends at least part way through the thickness of the metal plate.

12. The food heating device of claim 1, wherein the metal plate has a heat transfer coefficient k1 and wherein the thermal break is comprised of a solid material sandwiched between first and second regions of the plurality of regions such that the thermal break extends at least part way through and at least part way across the metal plate and has a heat transfer coefficient k₂, that is less than k₁.

13. The food heating device of claim 1, wherein the thermal break is comprised of at least one void formed within the metal plate, between the first and second regions and which extends at least part way across the metal plate.

14. The food heating device of claim 1, wherein the metal plate has first and second opposing sides, at least one of which is substantially planar.

15. The food heating device of claim 14, wherein the first and second sides are substantially parallel to each other.

16. The food heating device of claim 1 wherein the plurality of regions include first and second regions and wherein the first separately heated region and the second separately heated region are of different geometric areas, having equal length dimensions but different width dimensions.

17. The food heating device of claim 1, wherein a first separately heated region is heated by a first heating element and wherein a second separately heated region is heated by a second heating element, said first and second heating elements being individually controllable and embedded in the material from which the platen is made.

18. The food heating device of claim 17, wherein the first and second heating elements are electrically resistive material.

19. The food heating device of claim 18, wherein at least one of the first and second heating elements is boustrophedonic.

20. The food heating device of claim 18, wherein at least one of the first and second heating elements is crenellated.

21. The food heating device of claim 1, further comprised of a friction-reducing material adjacent the surface of the metal plate.

22. The food heating device of claim 1, wherein the metal plate is comprised of aluminum, and wherein the food heating device is further comprised of a friction-reducing material adjacent the surface of the aluminum plate.

23. The food heating device of claim 1, including a layer of polytetrafluoroethylene (PTFE) adjacent the surface of at least one of the first and second separately heated regions.

24. The food heating device of claim 1, including a sheet of polytetrafluoroethylene (PTFE), essentially free of fiberglass and comprised essentially of PTFE filaments that interlock each other at angles between 15 and 175 degrees.

25. A food heating device comprised of:
first and second metal plates, each of which has at least one heated regions, the first and second metal plates being separated from each other by a thermal break;
at least one conveyor, configured to move a food product across the surface of at least one of the first and second metal plates.

26. The food heating device of claim 25, wherein the first metal plate includes a first embedded heating element and wherein the second metal plate includes a second embedded heating element.

27. The food heating device of claim 26, wherein the first and second heating elements can be selectively heated to at least a first temperature within a first temperature range and the second heated region can be selectively heated to at least a second temperature within a second temperature range.

28. The food heating device of claim 26, wherein first and second separately metal plates have first and second thicknesses respectively.

29. The food heating device of claim 26, wherein at least one of the first and second metal plates has a first top portion and a first bottom and wherein said at least one of the first and second metal plates has a thickness, which varies between said first top portion and the first bottom portion.
